(19) United States
(12) Patent Application Publication
(10) Pub. No.: US 2017/0193597 A1
(43) Pub. Date: Jul. 6, 2017

(54) TRANSACTION-BASED CREDIT EVALUATION AND PREDICTION OF CORPORATE COMPANIES BY INTEGRATING REAL-TIME EVENT INFORMATION

(71) Applicant: INTERNATIONAL BUSINESS MACHINES CORPORATION, Armonk, NY (US)

(72) Inventors: Keke Cai, Beijing (CN); Hongfei Li, Briarcliff Manor, NY (US); Robin Lougee, Yorktown Heights, NY (US); Buyue Qian, Ossinging, NY (US)

(21) Appl. No.: 14/983,791

(22) Filed: Dec. 30, 2015

(51) Int. Cl. G06Q 40/02

(52) U.S. Cl. CPC G06Q 40/025

(57) ABSTRACT

Provided is a mechanism to evaluate and predict credit ratings of corporations from a transaction perspective (i.e., on a transaction-by-transaction basis) by integrating real-time event and external information such as, for example, social media and news reports. In various embodiments, such a mechanism may be implemented via systems, methods and/or computer program products.

### BACKGROUND

Corporate credit ratings are essential tools for helping make investment decisions. Three main credit rating agencies are: MOODY'S, STANDARD AND POOR'S (S&P'S), and FITCH IBCA. These credit rating agencies provide a rating system to help investors determine the risk associated with investing in a specific company, investing instrument or market. Further, D&B has a vast database of credit profiles on millions of companies. In addition, customer credit scores are used to evaluate the risk that a person will not pay his/her debts.

Transaction risk has to do with the amount of risk that is incurred during the period of time that occurs between entering into some type of agreement or contract, and when the agreement or contract is finally settled. While the purchase of just about any type of security can involve some potential for changes during this period, the risk is usually higher in markets where changes take place quickly. One of the most common types of transaction risk has to do with shifts in the relative value of various currencies that are involved with the transaction.

Referring now to FIG. 1 is a block diagram depicting an example conventional automotive supply chain. As seen in this FIG. 1, a Raw Material Manufacturer 101 provides material to Tier 3/4/5/ Supplier 103, which in turn provides a part to Tier 2 Supplier 105, which in turn provides a part to Tier 1 Supplier 107, which in turn provides a part to Car Manufacturer 109 (and possibly Consumer 115), which in turn provides vehicle/spare part to National Distributor 111, which in turn provides vehicle/spare part to Dealer 113, which in turn provides vehicle/spare part to Consumer 115.

In this regard, that is, with respect to the example automotive supply chain, it is noted that such supply chains are susceptible to being disrupted. For example, the effects from the earthquake, tsunami and the nuclear crisis in Japan in 2011 disrupted global supply chains. GENERAL MOTORS had to halt production of vehicles at several plants, due to parts shortages from Japanese suppliers. TOYOTA suspended production of parts in its home country that were intended to be shipped overseas. Finally, most Japanese automotive assembly plants closed. The automotive supply chain is about as complex as it gets. There are approximately 20,000 parts in a car, and if only one of those parts is unavailable, then it is possible that the finished product cannot be shipped. Furthermore, many Japanese components are transported by container ships, which may take 30 days to reach U.S. and European docks. So, it is likely that many problems will show up a month in the future when automakers run into parts bottlenecks.

Accordingly, as described herein the present disclosure provides a mechanism for corporate credit evaluation and prediction that will help with, for example, a company's operation planning with trading partners. In various embodiments, such a mechanism may be implemented via systems, methods and/or computer program products.

Further, as described herein the present disclosure provides a mechanism to evaluate and predict credit ratings of corporate companies from a transaction perspective (i.e., on a transaction-by-transaction basis) by integrating real-time event and external information such as, for example, social media and news reports. In various embodiments, such a mechanism may be implemented via systems, methods and/or computer program products.

### SUMMARY

Generally, various embodiments relate to innovations in commerce. More specifically, various embodiments provide a mechanism for evaluating credit risk of a company on a transaction-by-transaction basis. The evaluation of credit risk is an essential part of today's business environment. Typically businesses rely on third-party credit rating agencies to collect relevant information, actively monitor, and issue credit ratings for companies. These credit ratings can affect the willingness and terms with which companies will perform business transactions. However, there is currently no known mechanism capable of assessing credit risk on a transaction-by-transaction basis as described herein. This invention provides a mechanism for performing such transaction-based credit risk assessments.

In various examples, the assessment works by developing machine learned models based on historical data on corporate profiles, transactions, and real-world events. Both the immediate and long-term impacts on credit ratings of events can be modeled with sufficient data. Using the learned models along with real-time event data and information about the transaction, the immediate and long-term impacts on credit risk can be assessed.

In one embodiment, a computer-implemented method for predicting a credit rating of a corporation on a transaction-by-transaction basis is provided, the method comprising: obtaining, by a processor, real-time event information associated with the corporation; assessing by the processor, for a given transaction to be entered into with the corporation, an immediate impact to a transaction risk associated with the corporation, wherein the assessing the immediate impact to the transaction risk associated with the corporation is based at least in part upon the real-time event information associated with the corporation; assessing by the processor, for the given transaction to be entered into with the corporation, a long-term impact to the transaction risk associated with the corporation, wherein the assessing the long-term impact to the transaction risk associated with the corporation is based at least in part upon the real-time event information associated with the corporation; and outputting, by the processor, data indicative of the assessed immediate impact to the transaction risk associated with the corporation and the assessed long-term impact to the transaction risk associated with the corporation.

In another embodiment, a computer readable storage medium, tangibly embodying a program of instructions executable by the computer for predicting a credit rating of a corporation on a transaction-by-transaction basis is provided, the program of instructions, when executing, performing the following steps: obtaining real-time event information associated with the corporation; assessing, for a given transaction to be entered into with the corporation, an immediate impact to a transaction risk associated with the corporation, wherein the assessing the immediate impact to the transaction risk associated with the corporation is based at least in part upon the real-time event information associated with the corporation; assessing, for the given transaction to be entered into with the corporation, a long-term impact to the transaction risk associated with the corporation, wherein the assessing the long-term impact to the transaction risk associated with the corporation is based at least in part upon the real-time event information associated with the corporation; and outputting data indicative of the assessed immediate impact to the transaction risk associated with the corporation and the assessed long-term impact to the transaction risk associated with the corporation.

In another embodiment, a computer-implemented system for predicting a credit rating of a corporation on a transaction-by-transaction basis is provided, the system comprising: a processor; and a memory storing computer readable instructions that, when executed by the processor, implement: an obtaining element configured to obtain real-time event information associated with the corporation; a first assessing element configured to assess, for a given transaction to be entered into with the corporation, an immediate impact to a transaction risk associated with the corporation, wherein the assessing the immediate impact to the transaction risk associated with the corporation is based at least in part upon the real-time event information associated with the corporation; a second assessing element configured to assess, for the given transaction to be entered into with the corporation, a long-term impact to the transaction risk associated with the corporation, wherein the assessing the long-term impact to the transaction risk associated with the corporation is based at least in part upon the real-time event information associated with the corporation; and an outputting element configured to output data indicative of the assessed immediate impact to the transaction risk associated with the corporation and the assessed long-term impact to the transaction risk associated with the corporation.

### BRIEF DESCRIPTION OF THE DRAWINGS

Various objects, features and advantages of the present invention will become apparent to one skilled in the art, in view of the following detailed description taken in combination with the attached drawings, in which:

FIG. 1 depicts a block diagram showing an example of a conventional automotive supply chain.

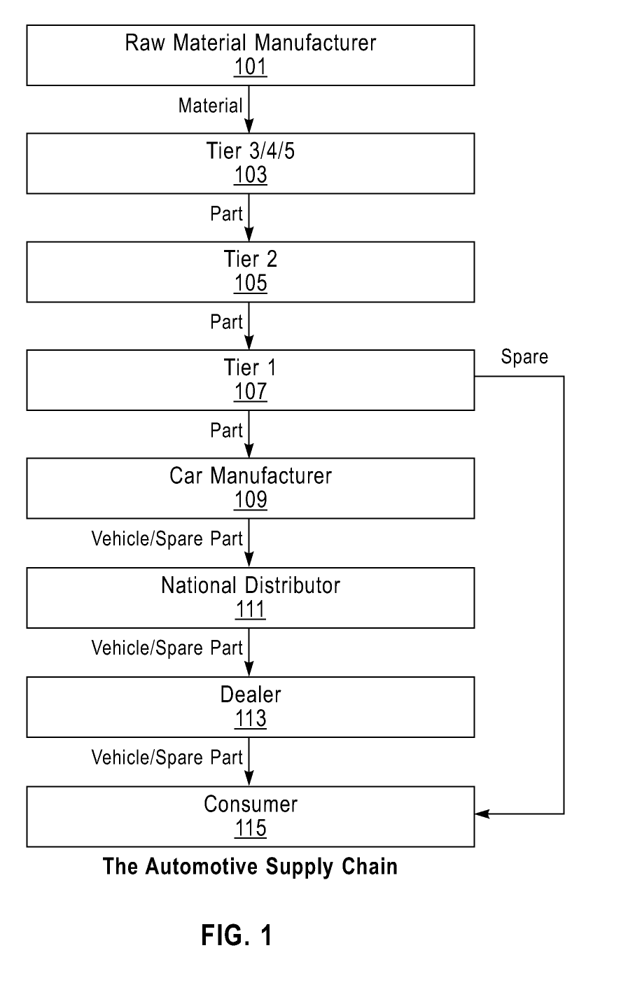

FIG. 2 depicts a block diagram of a system according to an embodiment.

FIG. 3 depicts a flowchart of a method according to an embodiment.

FIG. 4 depicts a block diagram of a system according to an embodiment.

FIG. 5 depicts a block diagram of a system according to an embodiment.

### DETAILED DESCRIPTION

As described herein, mechanisms are provided to evaluate and predict credit ratings of corporate companies from a transaction perspective (i.e., on a transaction-by-transaction basis) by integrating real-time event and external information (such as, for example, social media and news reports) while leveraging existing credit rating tool(s).

In this regard, it is likely that real-time external news or social media information cannot influence the overall credit of the corporation (particularly, if the corporation is very large). However, various disclosed mechanisms relate to the impact on corporate credit or risk for particular transactions due to real-time events. In one specific example, an event impact assessment engine is provided to analyze the immediate and long-term consequences that are relevant to corporate transactions. In another specific example, a mechanism is provided to predict transaction-based credit rating changes due to long-term impact of certain news and social media messages on corporate performance.

For the purposes of describing and claiming the present invention the phrase “real-time” (such as used in the context of “real-time event information”) is intended to refer to essentially the actual time during which a process or event occurs (but not necessarily simultaneously). In various specific examples, “real-time” may include a time-lag of up to a few seconds, up to a few minutes, up to a few hours, or up to one day.

For the purposes of describing and claiming the present invention the term “immediate” (such as used in the context of “immediate impact”) is intended to refer to a time horizon covering a current environment from a business perspective. In various specific examples, “immediate” may include a time-lag of up to a few seconds, up to a few minutes, up to a few hours, up to a few days, or up to three months (a business quarter).

For the purposes of describing and claiming the present invention the term “long-term” (such as used in the context of “long-term impact”) is intended to refer to a time horizon covering a future environment from a business perspective. In various specific examples, “long-term” may include a time-lag of greater than three months (a business quarter), at least a year, or multiple years. The term “long-term” defines a time span longer than a time span defined by the phrase “immediate”.

For the purposes of describing and claiming the present invention the term “transaction risk” is intended to refer to the risk that a given party to an agreement or contract will be unwilling or unable to perform its obligations under the agreement or contract.

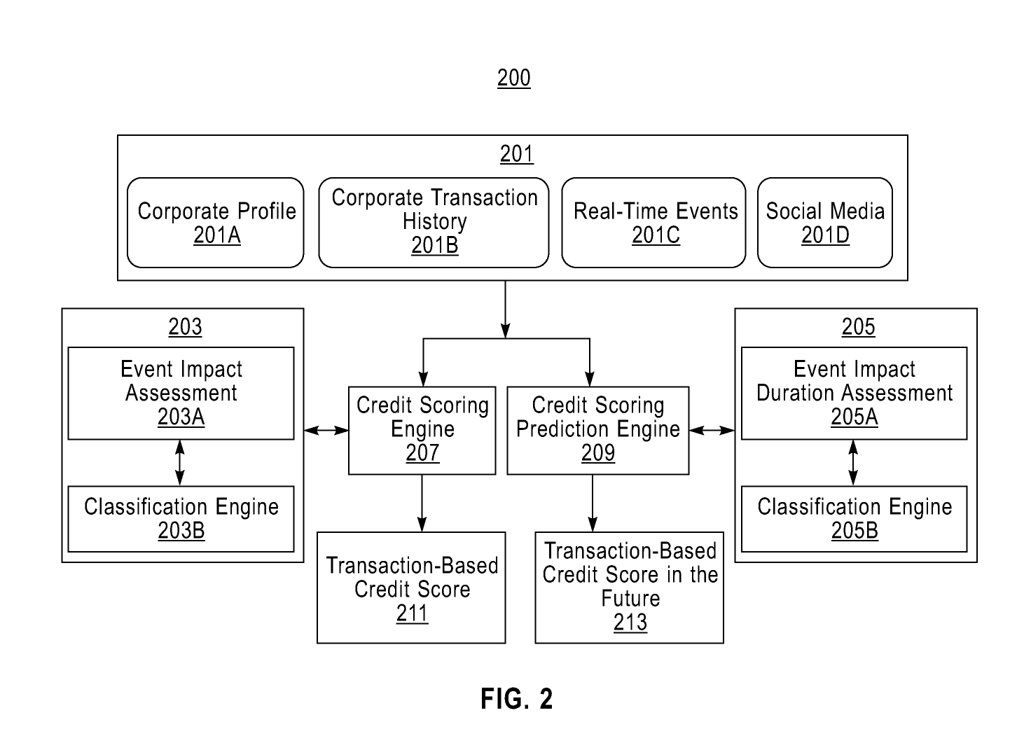

Referring now to FIG. 2, a block diagram of a transaction-based credit scoring system 200 according to an embodiment of the present invention is shown. As seen, information source 201 includes a corporate profile 201A, a corporate transaction history 201B a source of real-time events 201C and a source of social media information 201D (of course, any desired number of corporate profiles (such as for different corporations), any desired number of corporate transaction histories (such as for different corporations), any desired number of real-time events (such as for different corporations) and/or any desired number of social media feeds or information (such as for different corporations) may be provided.

Still referring to FIG. 2, information from information source 201 (for a given trading partner and given real-time event) is provided to credit scoring engine 207 and credit scoring prediction engine 209. Credit scoring engine 207 interacts with block 203 (including event impact assessment element 203A and classification engine 203B) to output a transaction-based credit score 211. In addition, credit scoring prediction engine 209 interacts with block 205 (including event impact duration assessment element 205A and classification engine 205B) to output a transaction-based credit score in the future 213 (that is, a prediction of a transaction-based credit score that will occur in the future).

In one example, credit scoring engine 207 may be used to estimate the risk of the company given the event impact in a short/intermediate time period. In one specific example, the flows start from analyzing short/intermediate-term event impact on company's operations, such as supply chain interruption, within one week. Then given the impact, the credit scoring engine 207 is used to assess the credit score of the company, which may change in short term. Further, in one example, credit scoring prediction engine 209 may be used to predict the credit risk for long term given the event impact lasting several months or even more. In this regard, event long-term impact may be evaluated and the result is plugged-in as the input to predict credit risk for the long term.

Referring now more particularly to event impact assessment element 203A, it is noted that this element may operate by: analyzing the high-profile nature of the event and the immediate consequences in terms of cause-effect relationship; and outputting event-impact factors that are relevant to the trading partner transactions (such factors have their values changed due to event impact).

Referring now more particularly to event impact duration assessment element 205A, it is noted that this element may operate by: analyzing the high-profile nature of the event and the long-term consequences in terms of cause-effect relationship; and outputting event-impact factors that are relevant to the trading partner transactions (such factors have their values changed in the long run due to event impact).

Referring now more particularly to classification engine 203B and classification engine 205B, it is noted that these elements may operate by using machine learning techniques to classify credit scores based on corporate profiles, corporate transaction history and event impact factors.

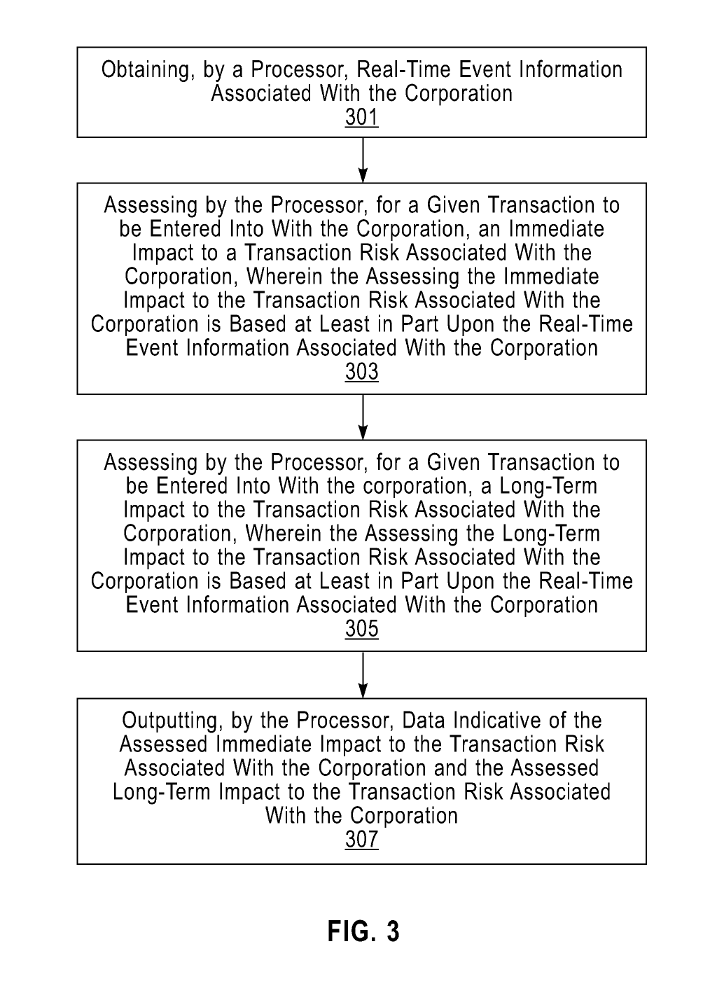

Referring now to FIG. 3, a method for predicting a credit rating (or risk) of a corporation on a transaction-by-transaction basis is shown. As seen in this FIG. 3, the method of this embodiment comprises: at 301—obtaining, by a processor, real-time event information associated with the corporation (such real-time event information may be obtained, for example, through news and social media); at 303—assessing by the processor, for a given transaction to be entered into with the corporation, an immediate impact to a transaction risk associated with the corporation, wherein the assessing the immediate impact to the transaction risk associated with the corporation is based at least in part upon the real-time event information associated with the corporation (the immediate impact can be learned, for example, through historical information by combing historical events and their corresponding immediate impacts); at 305—assessing by the processor, for the given transaction to be entered into with the corporation, a long-term impact to the transaction risk associated with the corporation, wherein the assessing the long-term impact to the transaction risk associated with the corporation is based at least in part upon the real-time event information associated with the corporation (the long-term impact can be learned, for example, through historical information by combing historical events and their corresponding long-term impacts); and at 307—outputting, by the processor, data indicative of the assessed immediate impact to the transaction risk associated with the corporation and the assessed long-term impact to the transaction risk associated with the corporation. In one example, the output data may be based upon long-term and immediate risk models that are classification engines (e.g., classification engines 205B and 203B) with outputs as risk scores, such as a value between 0 and 1. For example, event 1's immediate and long-term risks are 0.8 and 0.3, respectively and event 2's immediate and long-term risks are 0.5 and 0.8, respectively. That means that event 2 has lower immediate risk than event 1, but higher long-term risk. Further, it is noted that long-term and immediate risk models may be two analytics engines using different inputs of long-term and immediate event impact assessment respectively.

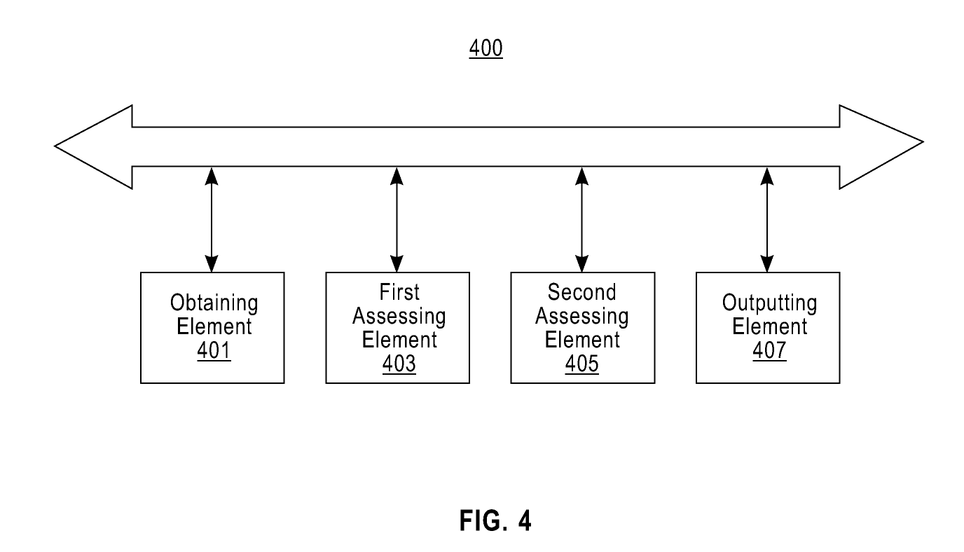

Referring now to FIG. 4, in another embodiment, a system 400 for predicting a credit rating (or risk) of a corporation on a transaction-by-transaction basis is provided. This system may include a processor (not shown); and a memory (not shown) storing computer readable instructions that, when executed by the processor, implement: an obtaining element 401 configured to obtain real-time event information associated with the corporation (such real-time event information may be obtained, for example, through news and social media); a first assessing element 403 configured to assess, for a given transaction to be entered into with the corporation, an immediate impact to a transaction risk associated with the corporation, wherein the assessing the immediate impact to the transaction risk associated with the corporation is based at least in part upon the real-time event information associated with the corporation (the immediate impact can be learned, for example, through historical information by combing historical events and their corresponding immediate impacts); a second assessing element 405 configured to assess, for the given transaction to be entered into with the corporation, an a long-term impact to the transaction risk associated with the corporation, wherein the assessing the long-term impact to the transaction risk associated with the corporation is based at least in part upon the real-time event information associated with the corporation (the long-term impact can be learned, for example, through historical information by combing historical events and their corresponding long-term impacts); and an outputting element 407 configured to output data indicative of the assessed immediate impact to the transaction risk associated with the corporation and the assessed long-term impact to the transaction risk associated with the corporation. In one example, the output data may be based upon long-term and immediate risk models that are classification engines (e.g., classification engines 205B and 203B) with outputs as risk scores, such as a value between 0 and 1. For example, event 1's immediate and long-term risks are 0.8 and 0.3, respectively and event 2's immediate and long-term risks are 0.5 and 0.8, respectively. That means that event 2 has lower immediate risk than event 1, but higher long-term risk. Further, it is noted that long-term and immediate risk models may be two analytics engines using different inputs of long-term and immediate event impact assessment respectively.

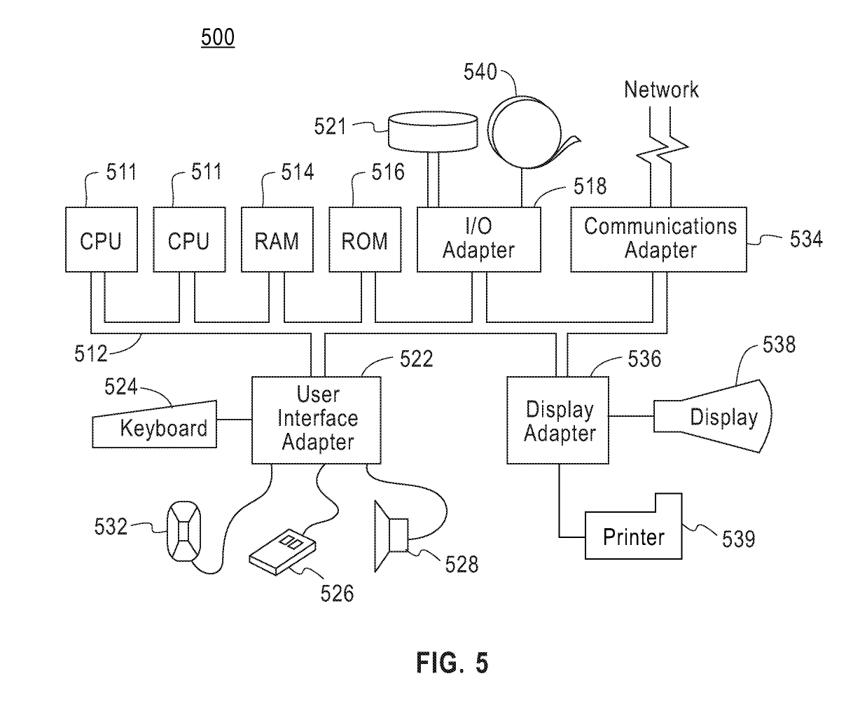

In one example, communication between and among the various components of FIG. 4 may be bi-directional. In another example, the communication may be carried out via the Internet, an intranet, a local area network, a wide area network and/or any other desired communication channel(s). In another example, each of the components may be operatively connected to each of the other components. In another example, some or all of these components may be implemented in a computer system of the type shown in FIG. 5.

Referring now to FIG. 5, this figure shows a hardware configuration of computing system 500 according to an embodiment of the present invention. As seen, this hardware configuration has at least one processor or central processing unit (CPU) 511. The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 526, speaker 528, microphone 532, and/or other user interface device to the bus 512), a communications adapter 534 for connecting the system 500 to a data processing network, the Internet, an Intranet, a local area network (LAN), etc., and a display adapter 536 for connecting the bus 512 to a display device 538 and/or printer 539 (e.g., a digital printer or the like).

As described herein, mechanisms are provided for determining, in real-time, risk based on market factors (in the context of transaction-by-transaction processing).

As described herein, mechanisms are provided to evaluate and predict credit ratings of corporate companies from a transaction perspective (i.e., on a transaction-by-transaction basis) by integrating real-time event and external information (such as, for example, social media and news reports) while leveraging existing credit rating tool(s). In one example, the immediate impact on corporate credit or risk for given transaction(s) due to real-time event(s) may be assessed (e.g., through the factors that are relevant to corporate transactions) and the long-term impact on corporate credit or risk for the given transaction(s) due to real-time event(s) may be assessed (e.g., through the factors that are relevant to corporate transactions). Further, machine-learning classification techniques may be used to model transaction-based credit ratings or risk based on corporate profiles, corporate transaction history and event impact factors.

As described herein are mechanisms which incorporate social media and/or other real-time event information.

As described herein are mechanisms which provide credit rating (or risk) prediction over time due to immediate event impact.

As described herein are mechanisms which provide credit rating (or risk) prediction over time due to long-term event impact.

In one embodiment, a computer-implemented method for predicting a credit rating of a corporation on a transaction-by-transaction basis is provided, the method comprising: obtaining, by a processor, real-time event information associated with the corporation; assessing by the processor, for a given transaction to be entered into with the corporation, an immediate impact to a transaction risk associated with the corporation, wherein the assessing the immediate impact to the transaction risk associated with the corporation is based at least in part upon the real-time event information associated with the corporation; assessing by the processor, for the given transaction to be entered into with the corporation, a long-term impact to the transaction risk associated with the corporation, wherein the assessing the long-term impact to the transaction risk associated with the corporation is based at least in part upon the real-time event information associated with the corporation; and outputting, by the processor, data indicative of the assessed immediate impact to the transaction risk associated with the corporation and the assessed long-term impact to the transaction risk associated with the corporation.

In one example, the method may further comprise obtaining, by the processor, a corporate profile of the corporation and a corporate transaction history of the corporation.

In another example, the assessing the immediate impact to the transaction risk associated with the corporation is further based at least in part upon the corporate profile of the corporation and the corporate transaction history of the corporation.

In another example, the assessing the immediate impact to the transaction risk associated with the corporation is performed via a machine-learning classification technique.

In another example, the machine-learning classification technique models a transaction-based risk.

In another example, the assessing the long-term impact to the transaction risk associated with the corporation is further based at least in part upon the corporate profile of the corporation and the corporate transaction history of the corporation.

In another example, the assessing the long-term impact to the transaction risk associated with the corporation is performed via a machine-learning classification technique.

In another example, the machine-learning classification technique models a transaction-based risk.

In another example, the real-time event information comprises at least one of: (a) a news report; (b) a message in a social media environment; and (c) any combination thereof.

In another embodiment, a computer readable storage medium, tangibly embodying a program of instructions executable by the computer for predicting a credit rating of a corporation on a transaction-by-transaction basis is provided, the program of instructions, when executing, performing the following steps: obtaining real-time event information associated with the corporation; assessing, for a given transaction to be entered into with the corporation, an immediate impact to a transaction risk associated with the corporation, wherein the assessing the immediate impact to the transaction risk associated with the corporation is based at least in part upon the real-time event information associated with the corporation; assessing, for the given transaction to be entered into with the corporation, a long-term impact to the transaction risk associated with the corporation, wherein the assessing the long-term impact to the transaction risk associated with the corporation is based at least in part upon the real-time event information associated with the corporation; and outputting data indicative of the assessed immediate impact to the transaction risk associated with the corporation and the assessed long-term impact to the transaction risk associated with the corporation.

In one example, the program of instructions, when executing, further performs obtaining a corporate profile of the corporation and a corporate transaction history of the corporation.

In another example, the assessing the immediate impact to the transaction risk associated with the corporation is further based at least in part upon the corporate profile of the corporation and the corporate transaction history of the corporation.

In another example, the assessing the immediate impact to the transaction risk associated with the corporation is performed via a machine-learning classification technique.

In another example, the machine-learning classification technique models a transaction-based risk.

In another example, the assessing the long-term impact to the transaction risk associated with the corporation is further based at least in part upon the corporate profile of the corporation and the corporate transaction history of the corporation.

In another example, the assessing the long-term impact to the transaction risk associated with the corporation is performed via a machine-learning classification technique.

In another example, the machine-learning classification technique models a transaction-based risk.

In another example, the real-time event information comprises at least one of: (a) a news report; (b) a message in a social media environment; and (c) any combination thereof.

In another embodiment, a computer-implemented system for predicting a credit rating of a corporation on a transaction-by-transaction basis is provided, the system comprising: a processor; and a memory storing computer readable instructions that, when executed by the processor, implement: an obtaining element configured to obtain real-time event information associated with the corporation; a first assessing element configured to assess, for a given transaction to be entered into with the corporation, an immediate impact to a transaction risk associated with the corporation, wherein the assessing the immediate impact to the transaction risk associated with the corporation is based at least in part upon the real-time event information associated with the corporation; a second assessing element configured to assess, for the given transaction to be entered into with the corporation, a long-term impact to the transaction risk associated with the corporation, wherein the assessing the long-term impact to the transaction risk associated with the corporation is based at least in part upon the real-time event information associated with the corporation; and an outputting element configured to output data indicative of the assessed immediate impact to the transaction risk associated with the corporation and the assessed long-term impact to the transaction risk associated with the corporation.

In one example, the outputting element is configured to output the data to at least one of: (a) a display; (b) a hardcopy printer; (c) a data storage device; and (d) any combination thereof.

In other examples, any steps described herein may be carried out in any appropriate desired order.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for predicting a credit rating of a corporation on a transaction-by-transaction basis, the method comprising:
obtaining, by a processor, externally sourced real-time event information associated with the corporation, the externally sourced real-time event information comprising information about a real-time event that is used to determine a transaction risk of the corporation;
obtaining, by the processor, historical information about:
historical events;
corresponding immediate impacts of the historical events on transaction risks of at least one corporation; and
corresponding long term impacts of the historical events on the transaction risks of the at least one corporation;
determining, by the processor, an immediate impact score for the corporation of the real-time event based at least in part on:
the externally sourced real-time event information; and
the historical events and the corresponding immediate impacts of the historical events on the transaction risks of the at least one corporation;
determining, by the processor, a long term impact score for the corporation of the real-time event based at least in part on:
the externally sourced real-time event information; and
the historical events and the corresponding long term impacts of the historical events on the transaction risks of the at least one corporation;
assessing, by the processor, for a transaction to be entered into with the corporation, an immediate impact to a transaction risk for the corporation associated with the transaction, wherein the assessing the immediate impact to the transaction risk for the corporation associated with the transaction is based at least in part upon the determined immediate impact score for the corporation of the real-time event;
assessing, by the processor, for the transaction to be entered into with the corporation, a long-term impact to the transaction risk for the corporation associated with the transaction wherein the assessing the long-term impact to the transaction risk for the corporation associated with the transaction is based at least in part upon the determined long-term impact score for the corporation of the real-time event; and
outputting, by the processor, a credit rating of the corporation for the transaction based on the assessed immediate impact to the transaction risk for the corporation associated with the transaction and the assessed long-term impact to the transaction risk for the corporation associated with the transaction.

2. The method of claim 1, further comprising obtaining, by the processor, a corporate profile of the corporation and a corporate transaction history of the corporation.

3. The method of claim 2, wherein the assessing the immediate impact to the transaction risk for the corporation associated with the transaction is further based at least in part upon the corporate profile of the corporation and the corporate transaction history of the corporation.

4. The method of claim 3, wherein the assessing the immediate impact to the transaction risk associated with the corporation is performed via a machine-learning classification technique.

5. The method of claim 4, wherein the machine-learning classification technique models a transaction-based risk.

6. The method of claim 2, wherein the assessing the long-term impact to the transaction risk for the corporation associated with the transaction is further based at least in part upon the corporate profile of the corporation and the corporate transaction history of the corporation.

7. The method of claim 6, wherein the assessing the long-term impact to the transaction risk for the corporation associated with the transaction is performed via a machine-learning classification technique.

8. The method of claim 7, wherein the machine-learning classification technique models a transaction-based risk.

9. The method of claim 1, wherein the externally sourced real-time event information comprises at least one of: (a) a news report; (b) a message in a social media environment; and (c) any combination thereof.

10. A non-transitory computer readable storage medium, tangibly embodying a program of instructions executable by the computer for predicting a credit rating of a corporation on a transaction-by-transaction basis, the program of instructions, when executing, performing the following steps:
obtaining externally sourced real-time event information associated with the corporation, the externally sourced real-time event information comprising information about a real-time event that is used to determine a transaction risk of the corporation;
obtaining historical information about:
historical events;
corresponding immediate impacts of the historical events on transaction risks of at least one corporation; and
corresponding long term impacts of the historical events on the transaction risks of the at least one corporation;
determining an immediate impact score for the corporation of the real-time event based at least in part on:
the externally sourced real-time event information; and
the historical events and the corresponding immediate impacts of the historical events on the transaction risks of the at least one corporation;
determining a long term impact score for the corporation of the real-time event based at least in part on:
the externally sourced real-time event information; and
the historical events and the corresponding long term impacts of the historical events on the transaction risks of the at least one corporation;
assessing, for a transaction to be entered into with the corporation, an immediate impact to a transaction risk for the corporation associated with the transaction, wherein the assessing the immediate impact to the transaction risk for the corporation associated with the transaction is based at least in part upon the determined immediate impact score for the corporation of the real-time event;
assessing, for the transaction to be entered into with the corporation, a long-term impact to the transaction risk for the corporation associated with the transaction, wherein the assessing the long-term impact to the transaction risk for the corporation associated with the transaction is based at least in part upon the determined long-term impact score for the corporation of the real-time event; and
outputting a credit rating of the corporation for the transaction based on the assessed immediate impact to the transaction risk for the corporation associated with the transaction and the assessed long-term impact to the transaction risk for the corporation associated with the transaction.

11. The non-transitory computer readable storage medium of claim 10, wherein the program of instructions, when executing, further performs obtaining a corporate profile of the corporation and a corporate transaction history of the corporation.

12. The non-transitory computer readable storage medium of claim 11, wherein the assessing the immediate impact to the transaction risk for the corporation associated with the transaction is further based at least in part upon the corporate profile of the corporation and the corporate transaction history of the corporation.

13. The non-transitory computer readable storage medium of claim 12, wherein the assessing the immediate impact to the transaction risk for the corporation associated with the transaction is performed via a machine-learning classification technique.

14. The non-transitory computer readable storage medium of claim 13, wherein the machine-learning classification technique models a transaction-based risk.

15. The non-transitory computer readable storage medium of claim 11, wherein the assessing the long-term impact to the transaction risk for the corporation associated with the transaction is further based at least in part upon the corporate profile of the corporation and the corporate transaction history of the corporation.

16. The non-transitory computer readable storage medium of claim 15, wherein the assessing the long-term impact to the transaction risk for the corporation associated with the transaction is performed via a machine-learning classification technique.

17. The non-transitory computer readable storage medium of claim 16, wherein the machine-learning classification technique models a transaction-based risk.

18. The non-transitory computer readable storage medium of claim 10, wherein the externally sourced real-time event information comprises at least one of: (a) a news report; (b) a message in a social media environment; and (c) any combination thereof.

19. A computer-implemented system for predicting a credit rating of a corporation on a transaction-by-transaction basis, the system comprising:
a processor; and
a memory storing computer readable instructions that, when executed by the processor, implement:
an obtaining element configured to:
obtain externally sourced real-time event information associated with the corporation, the externally sourced real-time event information comprising information about a real-time event that is used to determine a transaction risk of the corporation;
obtain historical information about:
historical events;
corresponding immediate impacts of the historical events on transaction risks of at least one corporation; and
corresponding long term impacts of the historical events on the transaction risks of the at least one corporation;
a the credit scoring engine configured to:
determine an immediate impact score for the corporation of the real-time event based at least in part on:
the externally sourced real-time event information; and
the historical events and the corresponding immediate impacts of the historical events on the transaction risks of the at least one corporation;
determine a long term impact score for the corporation of the real-time event based at least in part on:
the externally sourced real-time event information; and
the historical events and the corresponding long term impacts of the historical events on the transaction risks of the at least one corporation;
a first assessing element configured to assess, for a transaction to be entered into with the corporation, an immediate impact to a transaction risk for the corporation associated with the transaction, wherein the assessing the immediate impact to the transaction risk for the corporation associated with the transaction is based at least in part upon the determined immediate impact score for the corporation of the real-time event;
a second assessing element configured to assess, for the transaction to be entered into with the corporation, a long-term impact to the transaction risk for the corporation associated with the transaction, wherein the assessing the long-term impact to the transaction risk for the corporation associated with the transaction is based at least in part upon the determined immediate impact score for the corporation of the real-time event; and
an outputting element configured to output a credit rating of the corporation for the transaction based on the assessed immediate impact to the transaction risk for the corporation associated with the transaction and the assessed long-term impact to the transaction risk for the corporation associated with the transaction.

20. The system of claim 19, wherein the outputting element is configured to output the data to at least one of: (a) a display; (b) a hardcopy printer; (c) a data storage device; and (d) any combination thereof.
